(19) United States
(12) Patent Application Publication
(10) Pub. No.: US 2008/0281966 A1
(43) Pub. Date: Nov. 13, 2008

(54) METHOD AND SYSTEM OF NETWORK COMMUNICATION PRIVACY BETWEEN NETWORK DEVICES

(75) Inventors: Raymond B. Jennings, III, Ossining, NY (US); Hugo M. Krawczyk, Tarrytown, NY (US); Debanjan Saha, Mohegan Lake, NY (US)

Correspondence Address: CANTOR COLBURN LLP-IBM YORKTOWN, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/745,053

(22) Filed: May 7, 2007

(51) Int. Cl. G06F 15/173

(52) U.S. Cl. 709/225

(57) ABSTRACT

A method for network communication privacy between network devices includes communicating first and second network enabled devices with a network, the first and second network devices in communication via a main communication channel. Respective network addresses of the first and second network enabled devices are dynamically and automatically changed while maintaining the main communication channel between the first and second network enabled devices. Subsequent network addresses of the first and second network enabled devices are created in one of a symmetric manner using a secret key or predetermined list shared between the first and second network enabled devices or created in an asymmetric manner. The asymmetric manner includes communicating the subsequent network addresses of the first and second network enabled devices over a back channel separate from the main communication channel.

### TRADEMARKS

IBM® is a registered trademark of International Business Machines Corporation, Armonic, N.Y., U.S.A. Other names used herein may be registered trademarks, trademarks or product names of International Business Machines Corporation or other companies.

### BACKGROUND OF THE INVENTION

1. Field of the Invention

This invention relates generally to computer networking, and particularly to randomly selecting a set of network addresses for use in communication between two or more network devices.

2. Description of Background

Typically, the creation of a virtual private network (VPN), which hides the contents of data between two endpoints, is employed to create a private communication channel between the two endpoints. This normally involves using one or more methods of data encryption such that if someone were able to eavesdrop on the data, the eavesdropper would be unable to decrypt it. In addition, some type of authentication may be used where both endpoints are confident that they are communicating with whom they believe they are communicating with. A typical VPN does not necessarily protect the knowledge that two intended endpoints are in fact communicating, as the topmost network layer addresses must be available for proper routing through the network to occur. Given that these network layer addresses are visible; this could be used by an outside user, such as an attacker, to launch a denial of service (DoS) attack.

Another technique that is used to hide the fact that two endpoints are communicating is through the use of intermediate relay type network nodes. One example of this technique includes onion routing (OR) where each network node within a specific path only knows the identity of the previous network node and the next network node. However, problems associated with using intermediate relay nodes include additional latency of the network traffic, it does not prevent DoS attacks and any one or more intermediate nodes may become compromised. More specifically, onion routing does not provide perfect sender or receiver anonymity against all possible eavesdroppers—that is, it is possible for a local eavesdropper to observe that an individual has sent or received a message. It does provide for a strong degree of unlinkability, the notion that an eavesdropper cannot easily determine both the sender and receiver of a given message. Even within these confines, onion routing does not provide any absolute guarantee of privacy; rather, it provides a continuum in which the degree of privacy is generally a function of the number of participating routers versus the number of compromised or malicious routers.

Therefore, there remains a need for a method and system which provide network communication privacy between at least two endpoint enabled network devices of the network to prevent DoS attacks and monitoring by an outside user.

### SUMMARY OF THE INVENTION

The shortcomings of the prior art are overcome and additional advantages are provided through the provision of a method and system for network communication privacy between network devices. The method includes communicating first and second network enabled devices with a network, the first and second network devices in communication via a main communication channel. Respective network addresses of the first and second network enabled devices are dynamically and automatically changed while maintaining the main communication channel between the first and second network enabled devices. Subsequent network addresses of the first and second network enabled devices are created in one of a symmetric manner using a secret key or predetermined list shared between the first and second network enabled devices or created in an asymmetric manner. The asymmetric manner includes communicating the subsequent network addresses of the first and second network enabled devices over a back channel separate from the main communication channel.

In another embodiment, a method for network communication privacy between network enabled devices is disclosed. The method includes: communicating a first network enabled device with a network; communicating a second network enabled device with the network, the first and second devices in communication via a main communication channel; determining whether the second network enabled device has changed its network address using one of a predetermined list, a secret key or back channel connection shared between the first and second network devices, updating any network state associated with the connection between the first and second network enabled devices when the network address of the second network enabled device has changed; determining whether the first network enabled device should change its network address using one of the predetermined list, secret key or back channel connection shared between the first and second network devices; and obtaining a new network address for the first network enabled device if it is determined that the first network enabled device should change its network address using one of the key, predetermined list or back channel connection to generate the new network address.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

The technical effect of the present invention allows users of a network to randomly and quickly change their network identification (IP address) from a set of addresses. This technique prevents monitoring and network based attacks of a network enabled device by an outside user.

Known solutions include VPNs, secure proxies and application specific security solutions. None of which address the idea of allowing the user to become a moving target to prevent typical network based attacks.

As a result of the summarized invention, technically we have achieved a solution which allows users of a network to randomly and quickly change their network identification (IP address) from a set of addresses, thus preventing attack or monitoring from an outside user. In this manner, the users of at least two endpoint network enabled devices become a moving target to prevent network based attacks.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a schematic diagram illustrating a network with two devices communicating on the network over an open channel using a key shared between the two devices in accordance with an exemplary embodiment of the present invention.

FIG. 2 is a schematic diagram illustrating a network with two devices communicating on the network over an open channel and a back channel in accordance with an alternative exemplary embodiment of the present invention.

FIG. 3 is a schematic diagram illustrating a network with two devices communicating on the network over an open channel using a list shared between the two devices in accordance with yet another alternative exemplary embodiment of the present invention.

FIG. 4 is a flowchart diagram illustrating a method of changing a network address of a network device in accordance with an exemplary embodiment of the present invention.

The detailed description explains the preferred embodiments of the invention, together with advantages and features, by way of example with reference to the drawings.

### DETAILED DESCRIPTION OF THE INVENTION

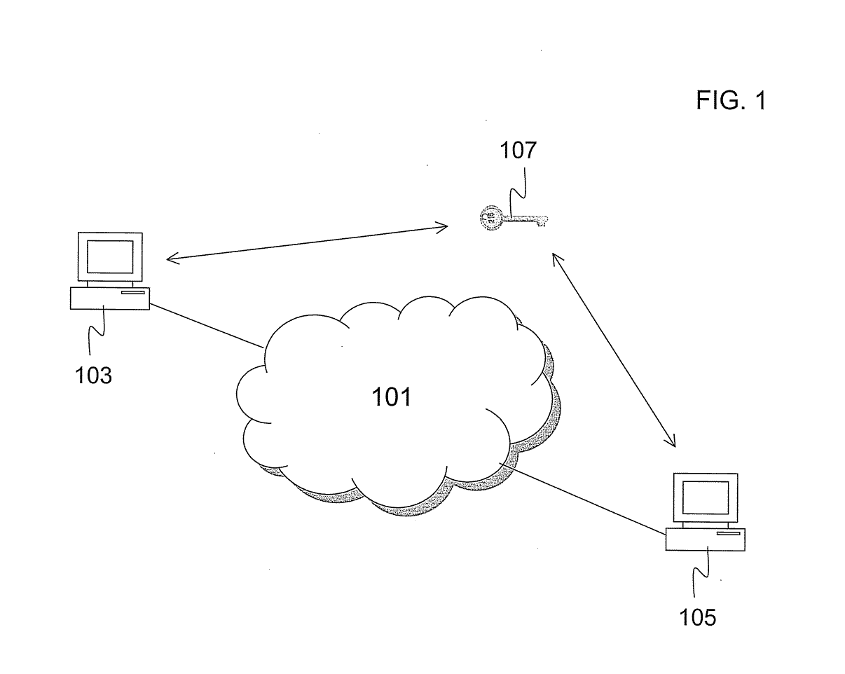

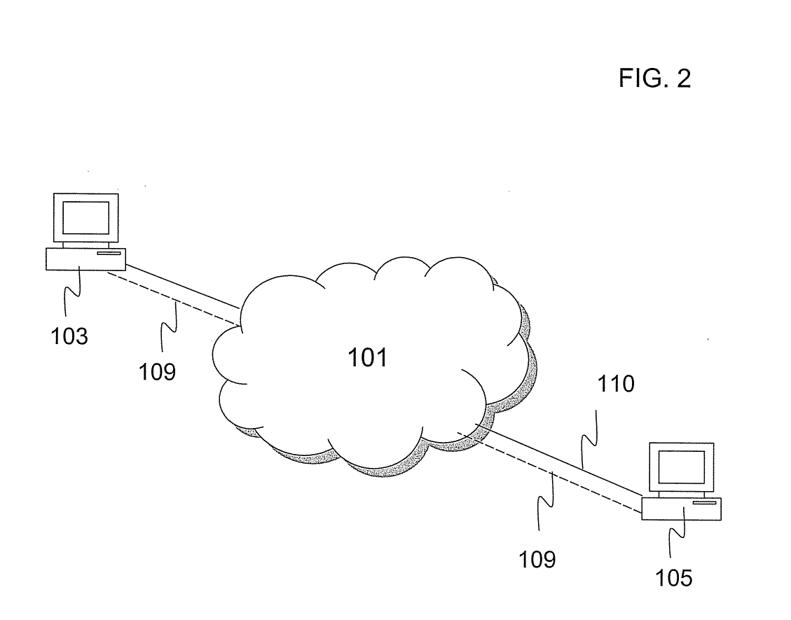

Turning now to the drawings in greater detail, it will be seen that FIG. 1 illustrates a method and system for randomly selecting multiple network addresses for communication between two or more network enabled devices in accordance with one embodiment of the present invention. The term network enabled device refers to any type of computing device capable of communicating over a network such as an IP based network. Referring now to FIG. 1, a network is shown as 101 which may be any type of network, including an IP Internet, for example, but is not limited thereto. Two network devices are shown as 103 and 105. Both network devices 103 and 105 can be any device capable of sending or receiving network packets and may be a specific hardware device or implemented as software running on a computer. A back channel is shown as 109 in FIG. 2, which may or may not exist in the embodiment of FIG. 1.

In one embodiment still referring to FIG. 1, devices 103 and 105 are communicating over network 101. A secret key 107 is known between devices 103 and 105. If either device 103 or 105 wishes to change their network address, the key 107 is used to generate a new network address. Different combinations with respect to how the secret key 107 is used by devices 103 and 105 may occur. In one example, devices 103 and 105 both use the secret key 107 to create a new network address, but devices 103 and 105 take turns using the address which is generated as their own address. Both devices 103 and 105 are required to use the key 107 to generate the new network address so that the devices 103 and 105 can either, use the key themselves or know what new network address the other device is now using. Therefore, for example, the device 103 would use the key 107 to generate its next address and the device 105 would use the key 107 to determine what address the device 103 is now using. In another example, the key 107 is also used to determine at what time the address change occurs. In general, a time value is generated using the key 107. The time value indicates at what offset into the future the next address should be selected by the device 103 or 105.

In another embodiment referring to FIG. 2, a back channel 109, shown with a phantom line, may be used to communicate when one device is changing its network address, both as to at what time and what new address for subsequent network device addresses. The back channel 109 may include for example, but is not limited thereto, a modem dial-up line which is suitable for sending small amounts of data but not suitable for the main data stream 110 which is sent between devices 103 and 105 using network 101. In this example, there does not need to be a secret key 107 between devices 103 and 105, but instead the back channel 109 as a separate private communication channel 109.

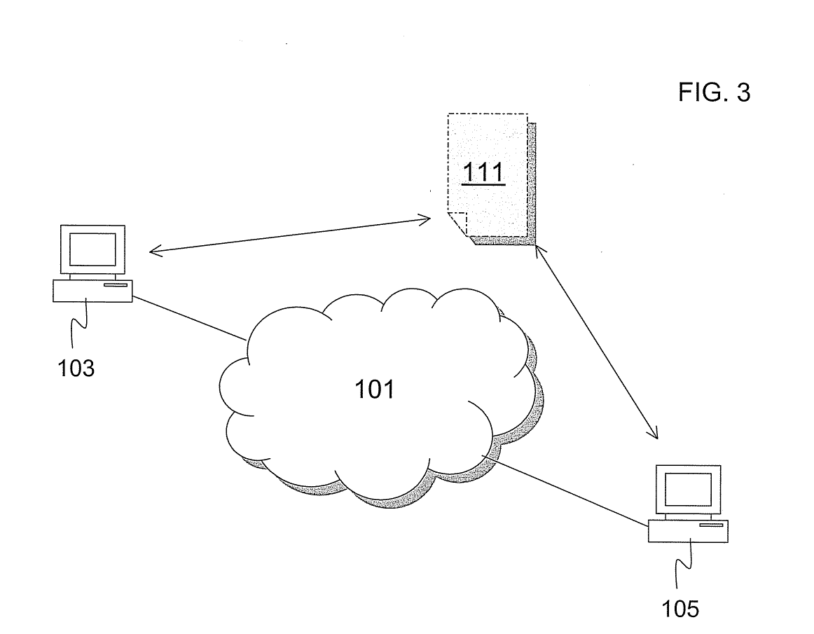

In still another embodiment referring to FIG. 3, a set or list 111 of network addresses and times are established before communication between devices 103 and 105 begins. The list 111 of addresses and address activation times is schematically depicted in FIG. 3 and may be exchanged between devices 103 and 105 using email or other traditional methods that are suitable and deemed secure.

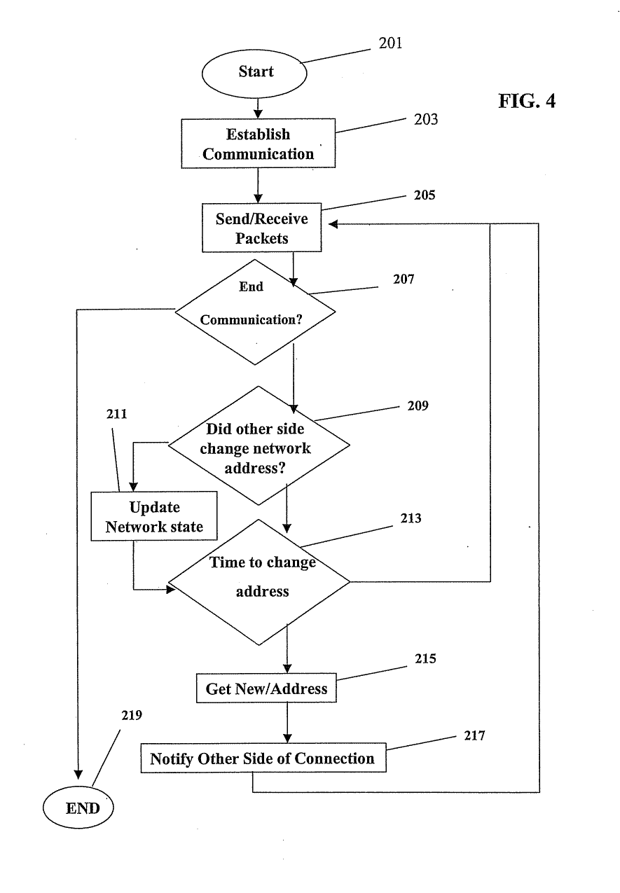

Referring now to FIG. 4, a flowchart describes the steps taken at a network device (e.g., device 103 or 105) when communicating using random network addresses. The process starts at step 201. Network communication begins with one or more network devices at step 203. At step 205 any network packets available (in the send queue or receive queue) are either sent or received by the network device (103 or 105). A determination is made at step 207 to determine if communication has ended with the network device started at step 203. If the condition at 207 is true or affirmative, the process ends at step 219, otherwise the flow continues to step 209 where a determination is made whether the other or remote network device has changed its network address. Step 209 may be accomplished by using a deterministic method such as a list (111, see FIG. 3), a secret key (107, see FIG. 1) or through an asynchronous means, such as a back channel connection 109, as in FIG. 2. If condition 209 is true or affirmative, then any network state associated with the connection between the two network devices must be updated given the new network address of the remote network device at step 211. The network state may include, but is not limited to, any layer (physical, network, transport, etc.) lists, buffers, counters or tables which are used to maintain the network connection.

If the network connection established at step 203 is a transmission control protocol (TCP) session, then any TCP session state must be updated on both TCP endpoints including network addresses, TCP ports, TCP sequence counters, acknowledgement counters and any data buffers. A TCP session includes a four triple (e.g., source network address and port and destination network address and port.) When a network address changes, this four triple needs to be updated within the context of the TCP session in order to keep the TCP session open and maintain the current acknowledgment and sequence numbers for the session. In the case where the connection is an “IP in IP” connection where IP packets are encapsulated in other IP packets, then it may be possible that no further state must be updated.

When the network connection established between the first and second network enabled devices is a transmission control protocol (TCP) session, then any TCP state must be updated including source network address, source port, destination network address, destination port, TCP sequence and acknowledgement counters and outstanding data buffers. The TCP sequence and acknowledgement numbers are updated (for both endpoints.) In other words if a TCP connection between two endpoints is already established and then the IP addresses of one or both endpoints change, then the TCP attributes need to be maintained, including the TCP ports as well as the current TCP sequence, last acknowledgement number and any outstanding sent or received data.

At step 213 a determination is made whether the local network device should change its network address. If the condition at 213 is false, the process continues at step 205. If the condition at 213 is true, then the process moves to step 215 where a new network address is obtained. Step 215 may include using a key (e.g., key 107 in FIG. 1) to generate a new network address, select one from a predetermined list (e.g., list 111 in FIG. 3) or request one from some other system or device. In addition, step 215 may be a combination of the previously mentioned methods. For example, only a segment of the network address may change such that the prefix of a network address may be fixed and only the suffix segment may change. At step 217, the other network device is notified of the local address change which may be done through a back channel 109 or automatically through the use of a secret key 107 where the remote network device can automatically determine when the local network device has changed, as well as what the new network device address is.

By allowing a user to randomly change IP addresses quickly, the user becomes a moving target for an attacker. In addition, if someone is monitoring network traffic for identity theft type crimes, for example, it becomes difficult for the monitoring agent to determine which IP address is being used at a particular time, as IP addresses are being randomly used and recycled with other users. The end result is essentially a “moving VPN” without encryption.

It is contemplated that a modified network stack for a network adaptor of a PC, for example, acquires multiple IP addresses using a dynamic form of IP aliasing. An aspect of the present disclosure is for the user's machine to use the different IP addresses at random (different TCP sessions use different IP addresses) to prevent other users from easily using network sniffers. Although network snoopers may still look at network packets, the snooper can never (easily) know who is using what IP address because the IP addresses are randomly used.

A user's network stack/adapter acquires a bulk of IP addresses. The same IP addresses are given out to multiple users but the network stack has a policy that only allows a particular IP address to be used at a certain time thereby guaranteeing no other user using this particular IP address at the same time. In other words, the modified dynamic host configuration protocol (DHCP) server gives out IP addresses and date ranges for when it can be used.

DHCP is a set of rules used by communications devices such as a computer, router or network adapter to allow the device to request and obtain an IP address from a server which has a list of addresses available for assignment. DHCP is a protocol used by networked computers (clients) to obtain IP addresses and other parameters such as the default gateway, subnet mask, and IP addresses of domain name system (DNS) servers from a DHCP server. It facilitates access to a network because these settings would otherwise have to be made manually for the client to participate in the network. The DHCP server ensures that all IP addresses are unique, e.g., no IP address is assigned to a second client while the first client's assignment is valid (its lease has not expired). Thus IP address pool management is done by the server and not by a human network administrator.

In computer networking, address resolution protocol (ARP) is the method for finding a host's hardware address when only its network layer address is known. ARP is primarily used to translate IP addresses to Ethernet media access control addresses (MAC addresses) (e.g., MAC address is unique identifier attached to most network adapters (NICs). In the present disclosure, the ARP protocol may be modified to be updated as each IP address expires or the first hop gateway may propagate all packets to all NICs that have registered this IP/MAC address. Because the network stack is modified, the network stack knows that the IP address is currently in the expired mode and can just discard duplicate packets.

In addition, the same thing can be applied to the link layer where random MAC addresses are used for the case where the packet sniffer is on the same link. This might be a little more difficult because for a given manufacturer the same MAC address prefix is supposed to be used. This wouldn't be a problem if all users had the same hardware (e.g., IBM). But in a mixed environment of hardware, the MAC address prefix may be filtered if this constraint is not lifted—or a globally used MAC address prefix may be created.

In summary, a method and system for randomly selecting multiple network addresses for communication between two or more network enabled devices has been disclosed. Each network device is kept in synchronization with the other network devices with respect to their changing network addresses. This technique enables communication channels to remain active to maintain state information about the network connection at other layers within the network stack.

In order to keep network devices in synchronization so that each side is aware of the network address change on the other side, one or more techniques may be used. In a first method, a secret key is used to generate a time and new address to use. Subsequent network addresses are created in a symmetric manner using the secret key between the two network devices. A second method includes creating the network addresses in an asymmetric manner using a back channel to communicate any changes between devices. A third method includes establishing a relatively static list which is known between all endpoints before communication has begun.

The above described embodiments describe means for randomly selecting a set of network addresses to be used between two or more network enabled devices. The term “randomly” is used because it gives the impression of being random to all other network devices. The methods for selecting a new network address are deterministic to the network devices involved within the communication channel in exemplary embodiments. The methods provide for network devices to essentially change their network addresses while still maintaining communication between each other. If the pool of available network addresses to select from is large enough then it becomes very difficult for an outside user to determine if two endpoints are communicating and difficult to launch an attack on the endpoints given the periodically changing addresses.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flowchart diagram depicted herein is just an example. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for network communication privacy between network devices, the method comprising:
communicating a first network enabled device with a network;
communicating a second network enabled device with the network, the first and second devices in communication via a main communication channel;
dynamically and automatically changing respective network addresses of the first and second network enabled devices while maintaining the main communication channel between the first and second network enabled devices;
wherein subsequent network addresses of the first and second network enabled devices are created in one of a symmetric manner using a secret key or predetermined list shared between the first and second network enabled devices or created in an asymmetric manner.

2. The method of claim 1, wherein the asymmetric manner includes communicating the subsequent network addresses of the first and second network enabled devices over a back channel separate from the main communication channel.

3. The method of claim 2, wherein the back channel is a separate private communication channel from the main communication channel.

4. The method of claim 3, wherein the private communication channel is a modem dial-up line in communication with the network.

5. The method of claim 1, wherein the list includes a set of addresses and activation times for the first and second network enabled devices.

6. The method of claim 5, further comprising sharing the list between the first and second network enabled devices before establishing communication between the first and second network enabled devices.

7. The method of claim 6, further comprising exchanging the set of addresses and activation times for the first and second network enabled devices via electronic mail.

8. The method of claim 1, further comprising maintaining connection state information including a transport layer data which is updated when network addresses change.

9. The method of claim 9, wherein real network communication data is encapsulated within changing network addresses.

10. The method of claim 1, wherein the network is an IP Internet.

11. The method of claim 1, wherein the first and second network enabled devices include a device configured to send and receive network packets.

12. A method for network communication privacy between network enabled devices, the method comprising:
communicating a first network enabled device with a network;
communicating a second network enabled device with the network, the first and second devices in communication via a main communication channel;
determining whether the second network enabled device has changed its network address using one of a predetermined list, a secret key or back channel connection shared between the first and second network devices, then
updating any network state associated with the connection between the first and second network enabled devices when the network address of the second network enabled device has changed;
determining whether the first network enabled device should change its network address using one of the predetermined list, secret key or back channel connection shared between the first and second network devices; and
obtaining a new network address for the first network enabled device if it is determined that the first network enabled device should change its network address using one of the key, predetermined list or back channel connection to generate the new network address.

13. The method of claim 12, wherein the network state includes network lists, buffers, counters or tables used to maintain the network connection between the first and second network enabled devices.

14. The method of claim 12, wherein when the network connection established between the first and second network enabled devices is a transmission control protocol (TCP) session, then any TCP state must be updated including network addresses, TCP ports, TCP sequence counters, TCP acknowledgement counters and outstanding data buffers of the first and second network enabled devices.

15. The method of claim 12, wherein when the network connection established between the first and second network enabled devices is an IP in IP connection where IP packets are encapsulated in other IP packets, no further state is updated.

16. The method of claim 12, further comprising changing only a segment of the network address to obtain the new network address.

17. The method of claim 16, wherein a prefix of a network address is fixed and only the suffix segment of the network address is changed to obtain the new network address.

18. A system for network communication privacy between network devices, the system comprising:
a network:
first and second devices in communication with the network, the first and second devices in communication via a main communication channel; and
means for dynamically and automatically changing respective network addresses of the first and second network enabled devices while maintaining the main communication channel between the first and second network enabled devices,
wherein subsequent network addresses of the first and second network enabled devices are created in one of a symmetric manner or an asymmetric manner.

19. The system of claim 18, wherein the asymmetric manner includes communicating the subsequent network addresses of the first and second network enabled devices over a back channel separate from the main communication channel and the symmetric manner includes using a secret key or predetermined list shared between the first and second network enabled devices.
